(19) United States
(12) Patent Application Publication
(10) Pub. No.: US 2022/0415098 A1
(43) Pub. Date: Dec. 29, 2022

(54) CAR WASHING DEVICE, CAR WASHING SYSTEM, CAR WASHING METHOD, AND STORAGE MEDIUM STORING CAR WASHING PROGRAM

(71) Applicant: TOYOTA JIDOSHA KABUSHIKI KAISHA, Aichi-ken (JP)

(72) Inventors: Teruaki HAIBARA, Ashigarakami-gun (JP); Kenji HOSHI, Gotemba-shi (JP); Masaaki SATO, Susono-shi (JP)

(21) Appl. No.: 17/849,712

(22) Filed: Jun. 27, 2022

(30) Foreign Application Priority Data
Jun. 29, 2021 (JP) 2021-107660

(51) Int. Cl. G07C 5/00

(52) U.S. Cl. CPC G07C 5/008

(57) ABSTRACT

A car washing includes a processor. The processor is configured to acquire vehicle type information and a travel history from a vehicle, estimate dirtiness of the vehicle based on the vehicle type information and the travel history, and execute car washing corresponding to an estimated degree of dirtiness.

### CROSS-REFERENCE TO RELATED APPLICATION

This application is based on and claims priority under 35 USC 119 from Japanese Patent Application No. 2021-107660 filed on Jun. 29, 2021, the disclosure of which is incorporated by reference herein.

### BACKGROUND

### Technical Field

The present disclosure relates to a car washing device, a car washing system, a car washing method, and a storage medium storing a car washing program.

### Related Art

Japanese Patent Application Laid-Open (JP-A) No. 2020-179709 discloses a car washing device that can wash a vehicle at an appropriate timing. In this car washing device, a processor calculates the timing of the next car washing of a vehicle based on history data that includes the washing history of the vehicle, and notifies a terminal, which is associated with the vehicle, of the next wash timing.

Moreover, on the basis of images of the vehicle that are inputted from a car wash, the degree of dirtiness of the vehicle is estimated, a car washing menu corresponding to the degree of dirtiness is determined, the car wash is controlled, and the vehicle is washed based on the determined car washing menu.

In the car washing device of JP-A No. 2020-179709, the degree of dirt removal differs for each vehicle type even in the same car washing menu, and therefore, there is room for improvement. In cases in which dirt is not easily removed, the time required for washing the vehicle, and resources such as washing water, cleaning agents, electric power and the like, are wasted by repeatedly washing the vehicle.

### SUMMARY

An object of the present disclosure is to provide a car washing device, a car washing system, a car washing method, and a storage medium storing a car washing program, that enable car washing to be performed with minimal time and resources.

A car washing device of a first aspect includes a processor, wherein the processor is configured to: acquire vehicle type information and a travel history from a vehicle; estimate dirtiness of the vehicle based on the vehicle type information and the travel history; and execute car washing corresponding to an estimated degree of dirtiness.

The car washing device of the first aspect estimates dirtiness of the vehicle based on the vehicle type information and the travel history acquired from the vehicle by the processor, and executes car washing corresponding to the estimated degree of dirtiness. Here, the vehicle type information includes information relating to the vehicle type, the grade, and the equipment of the vehicle. The travel history is information including a history of past travel of the vehicle, and includes information such as roads on which the vehicle has traveled, weather during travel, and the like. In accordance with the car washing device, by carrying out washing of the vehicle based on the vehicle type information and the travel history of the vehicle, car washing can be carried out by using minimal time and resources.

A car washing device of a second aspect is the car washing device of the first aspect, wherein the processor executes car washing beginning from a region having a high estimated degree of dirtiness.

In accordance with the car washing device of the second aspect, by carrying out car washing from a dirty region, the car washing can be carried out efficiently.

A car washing device of a third aspect is the car washing device of the first or second aspect, wherein the processor is configured to acquire a cleaned state of the vehicle after execution of car washing, and execute car washing once more in a case in which there is a region in which removal of dirt is insufficient.

In accordance with the car washing device of the third aspect, dirt of the vehicle can be removed even in cases in which the estimating of dirtiness is insufficient.

A car washing device of a fourth aspect is the car washing device of any one of the first through third aspects, wherein the processor is configured to acquire a cleaned state of the vehicle after execution of car washing, and, in a case in which there is a region in which removal of dirt is insufficient, notify a user that removal of dirt is insufficient.

In accordance with the car washing device of the fourth aspect, in a case in which removal of dirt is insufficient, the user can be asked to select whether additional car washing is to be carried out or car washing is to be ended.

A car washing device of a fifth aspect is the car washing device of any one of the first through fourth aspects, wherein the processor is configured to estimate the dirtiness of the vehicle based on a car washing history of the vehicle in addition to the vehicle type information and the travel history, and execute car washing corresponding to the estimated degree of dirtiness.

In the car washing device of the fifth aspect, the accuracy of estimating the dirtiness can be improved by adding the past car washing history of the vehicle to the vehicle type information and the travel history when estimating the dirtiness.

A sixth aspect is a car washing system including: the car washing device of any one of the first through fifth aspects; and a vehicle control device installed in the vehicle and connected to the car washing device by communication.

In accordance with the car washing system of the sixth aspect, by carrying out washing of the vehicle based on the vehicle type information and the travel history of the vehicle, car washing can be carried out by using minimal time and resources.

A seventh aspect is a car washing method, by which a computer executes processing including: acquiring vehicle type information and a travel history from a vehicle; estimating dirtiness of the vehicle based on the vehicle type information and the travel history; and executing car washing corresponding to an estimated degree of dirtiness.

In the car washing method of the seventh aspect, the computer estimates the dirtiness of the vehicle based on the vehicle type information and the travel history acquired from the vehicle, and executes car washing corresponding to the estimated degree of dirtiness. The vehicle type information and the travel history are as described above. In accordance with the car washing method, by carrying out washing of the vehicle based on the vehicle type information and the travel history of the vehicle, car washing can be carried out by using minimal time and resources.

An eighth aspect is a non-transitory storage medium storing a car washing program. The car washing program causes a computer to execute processings including: acquiring vehicle type information and a travel history from a vehicle; estimating dirtiness of the vehicle based on the vehicle type information and the travel history; and executing car washing corresponding to an estimated degree of dirtiness.

The car washing program of the eighth aspect causes a computer to execute the processings of estimating dirtiness of the vehicle based on the vehicle type information and the travel history that are acquired from the vehicle, and executing car washing corresponding to the estimated degree of dirtiness. The vehicle type information and the travel history are as described above. In accordance with the car washing program, by carrying out washing of the vehicle based on the vehicle type information and the travel history of the vehicle, car washing can be carried out by using minimal time and resources.

In accordance with the present disclosure, car washing can be carried out by using minimal time and resources.

### BRIEF DESCRIPTION OF THE DRAWINGS

An exemplary embodiment of the present disclosure will be described in detail based on the following figures, wherein:

FIG. 1 is a diagram illustrating the schematic structure of a car washing system relating to an exemplary embodiment;

FIG. 2 is a block diagram illustrating hardware structures of a vehicle of the exemplary embodiment;

FIG. 3 is a block diagram illustrating hardware structures of a car wash of the exemplary embodiment;

FIG. 4 is a block diagram illustrating functional structures of a control device of the car wash relating to the exemplary embodiment;

FIG. 5 is a sequence diagram illustrating the flow of processings between the vehicle and the car wash of the exemplary embodiment; and

FIG. 6 is a flowchart illustrating the flow of car washing processing executed at the control device of the exemplary embodiment.

### DETAILED DESCRIPTION

(Overall Structure)

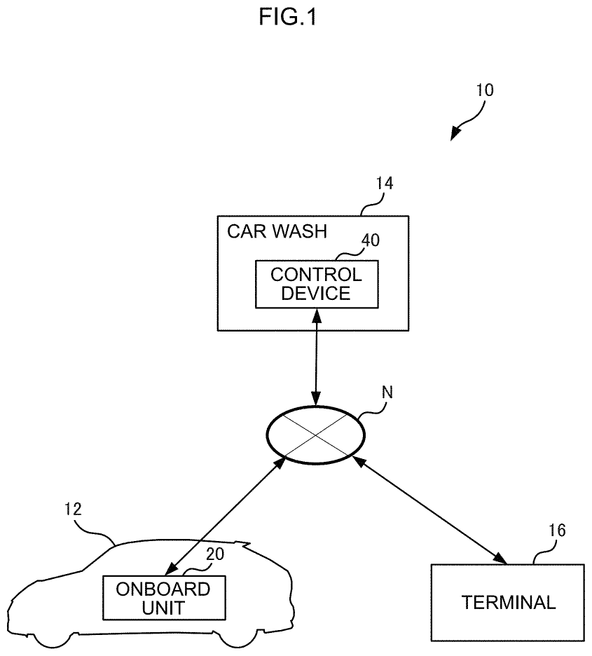

As illustrated in FIG. 1, a car washing system 10 of an exemplary embodiment of the present disclosure is structured to include at least a vehicle 12 and a car wash 14. Note that the car washing system 10 may include a terminal 16. Examples of the terminal 16 include a smartphone, personal computer, or the like that is possessed by the driver, owner, administrator, or the like of the vehicle 12.

An onboard unit 20 serving as a vehicle control device is installed in the vehicle 12. Moreover, a control device 40 serving as a car washing device is installed in the car wash 14. The onboard unit 20, the control device 40, and the terminal 16 are connected to each other through a network N. Note that the onboard unit 20 and the control device 40 may be directly connected by near field communication.

(Vehicle)

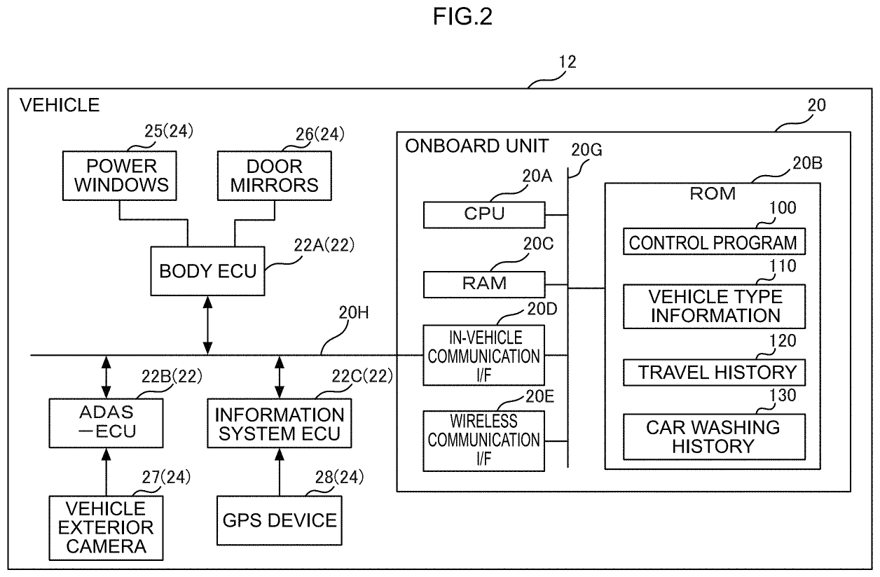

As illustrated in FIG. 2, the vehicle 12 relating to the present exemplary embodiment is configured to include the onboard unit 20, plural ECUs (Electronic Control Units) 22, and onboard devices 24.

The onboard unit 20 is configured to include a CPU (Central Processing Unit) 20A, a ROM (Read Only Memory) 20B, a RAM (Random Access Memory) 20C, an in-vehicle communication I/F (Interface) 20D, and a wireless communication I/F 20E. The CPU 20A, the ROM 20B, the RAM 20C, the in-vehicle communication I/F 20D, and the wireless communication I/F 20E are connected so as to be able to communicate with each other through an internal bus 20G.

The CPU 20A is a central processing unit that executes various programs and controls various units. Namely, the CPU 20A reads a program from the ROM 20B, and executes the program using the RAM 20C as a workspace.

The ROM 20B stores various programs and various data. A control program 100, vehicle type information 110, a travel history 120, and a car washing history 130 are stored in the ROM 20B of the present embodiment.

The control program 100 is a program having the functions of collecting information of various units of the vehicle 12 from the ECUs 22, and providing at least the vehicle type information 110, the travel history 120, and the car washing history 130 of the vehicle 12 to the car wash 14.

The vehicle type information 110 includes at least information relating to the vehicle type, the grade, and the equipment of the vehicle 12. Note that the vehicle type information 110 may include the external dimensions of and images of the external appearance of the vehicle 12.

The travel history 120 is information including the history of past travel of the vehicle 12, and includes information such as roads on which the vehicle 12 has traveled, the weather during travel, and the like. The travel history 120 is generated or updated based on images of the exterior of the vehicle 12 collected from an ADAS (Advanced Driver Assistance System)-ECU 22B that is described later, and position information of the vehicle 12 collected from an information system ECU 22C, and the like. Moreover, the travel history 120 includes weather information that has been collected on the basis of a vehicle exterior camera 27 that is described later, or that has been acquired from the exterior of the vehicle 12.

The car washing history 130 is information including the history of car washes carried out on the vehicle 12 in the past. The car washing history 130 includes at least the date and time when car washing was carried out, and is updated each time car washing is carried out.

The RAM 20C temporarily stores programs and data as a workspace.

The in-vehicle communication I/F 20D is an interface for connection with the respective ECUs 22. A communication standard based on CAN protocol is used at the interface. The in-vehicle communication I/F 20D is connected to an external bus 20H, and the respective ECUs 22 are connected to the external bus 20H.

The wireless communication I/F 20E is a wireless communication module for communicating with the control device 40 of the car wash 14. For example, a communication standard such as 5G, LTE, or Wi-Fi(registered trademark) is used at this wireless communication module. The wireless communication I/F 20E is connected to the network N.

The ECUs 22 include a body ECU 22A, the ADAS-ECU 22B, and the information system ECU 22C.

The body ECU 22A controls the onboard devices 24 of the various units of the body of the vehicle 12. Power windows 25 and door mirrors 26 that configure the onboard devices 24 are connected to the body ECU 22A.

The ADAS-ECU 22B carries out overall control of the advanced driving assistance system. At least the vehicle exterior camera 27 is connected to the ADAS-ECU 22B as an external sensor that configures the onboard devices 24.

The information system ECU 22C controls the car navigation system, the audio system, and the like. A GPS device 28 structuring the onboard devices 24 is connected to the information system ECU 22C. The GPS device 28 is a device that measures the current position of the vehicle 12. The GPS device 28 includes an antenna that receives signals from GPS satellites. Note that the GPS device 28 may be directly connected to the onboard unit 20.

(Car Wash)

The car wash 14 is a machine that automatically washes the vehicle 12. Examples of the car wash 14 of the present exemplary embodiment are a gate type in which the main body of the car wash 14 moves relative to the vehicle 12 to perform car washing, and a drive-through type in which the vehicle 12 is washed by passing-through the interior of the main body of the car wash 14.

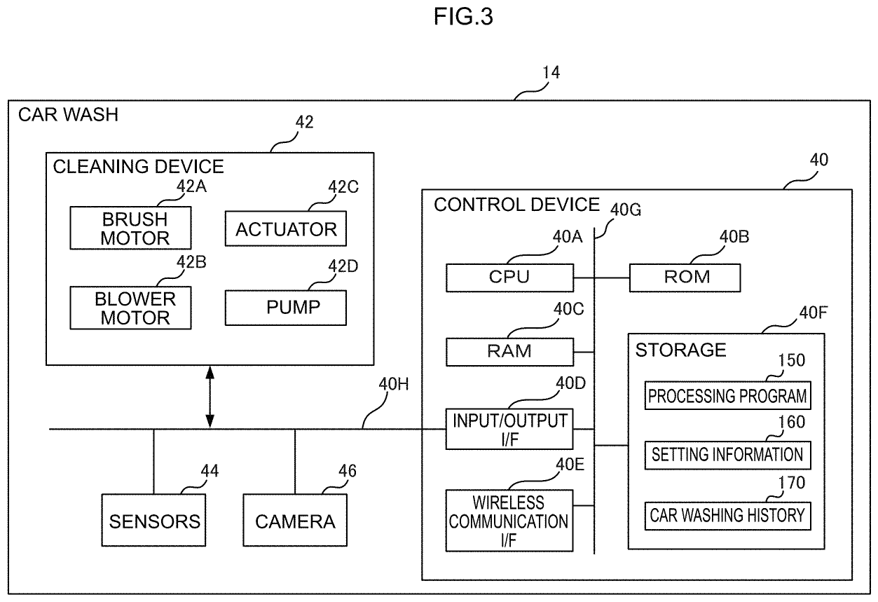

As illustrated in FIG. 3, the car wash 14 is configured to include the control device 40, a cleaning device 42, sensors 44, and a camera 46. Note that the sensors 44 and the camera 46 may be included in the cleaning device 42.

The control device 40 has the function of controlling the cleaning device 42. The control device 40 is configured to include a CPU 40A, a ROM 40B, a RAM 40C, an input/output I/F 40D, a wireless communication I/F 40E, and a storage 40F. The CPU 40A, the ROM 40B, the RAM 40C, the input/output I/F 40D, the wireless communication I/F 40E, and the storage 40F are connected so as to be able to communicate with each other through an internal bus 40G. The functions of the CPU 40A, the ROM 40B, the RAM 40C, and the wireless communication I/F 40E are the same as those of the CPU 20A, the ROM 20B, the RAM 20C, and the wireless communication I/F 20E of the onboard unit 20 described above.

The input/output I/F 40D is an interface for communication with the cleaning device 42, the sensors 44, and the camera 46. The input/output I/F 40D is connected to an external bus 40H, and the cleaning device 42, the sensors 44, and the camera 46 are connected to the external bus 40H.

The storage 40F is configured by an HDD (Hard Disk Drive) or an SSD (Solid State Drive), and stores various programs and various data. A processing program 150, setting information 160, and car washing history 170 are stored in the storage 40F of the present exemplary embodiment. Note that the ROM 40B may store the processing program 150, the setting information 160, and the car washing history 170.

The processing program 150 that serves as the car washing program is a program for controlling the control device 40. Accompanying execution of the processing program 150, the control device 40 drives the cleaning device 42 and executes car washing processing that relates to washing the vehicle 12.

Information relating to a car washing menu, which corresponds to the vehicle type and/or the equipment of the vehicle 12, is collected in the setting information 160.

The car washing history 170 is information including the history of car washes that have been executed by the car wash 14. The car washing history 170 includes at least the date and time when car washing was carried out, and is updated each time car washing is carried out.

The cleaning device 42 includes at least brush motors 42A, blower motors 42B, actuators 42C, and pumps 42D.

The brush motors 42A are motors that rotate brushes that clean the vehicle body surfaces of the vehicle 12, and are provided respectively for the plural brushes that are at the main body of the car wash 14.

The blower motors 42B are motors that drive blowers for blowing compressed air onto the vehicle body surfaces of the vehicle 12, and are provided respectively for the plural blowers that are at the main body of the car wash 14.

The actuators 42C are provided as a drive unit for moving the brushes and the blowers along the vehicle body surfaces.

The pumps 42D are provided to feed, under pressure, cleaning water, cleaning agents, and the like.

The sensors 44 are provided at various units of the main body of the car wash 14 and sense the vehicle body surfaces of the vehicle 12. The control device 40 drives the actuators 42C based on information sensed by the sensors 44, and moves the brushes and the blowers along the vehicle body surfaces.

The camera 46 is an image capturing device that captures images of vehicle body surfaces of the vehicle 12. The camera 46 is installed at a position away from the brushes, or includes a shutter that is openable and closable, so as not to be affected by the cleaning water and the cleaning agents.

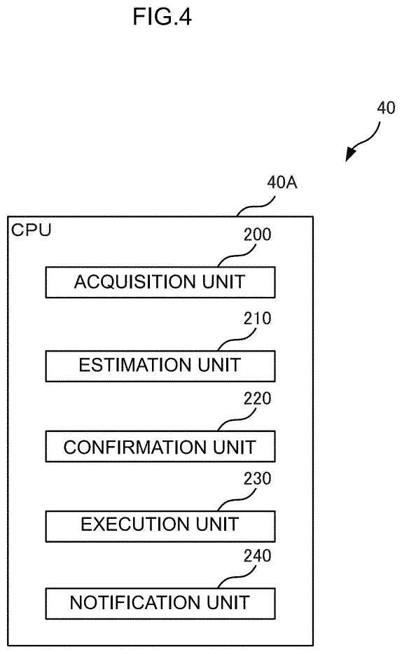

As illustrated in FIG. 4, at the control device 40 of the present exemplary embodiment, by executing the processing program 150, the CPU 40A functions as an acquisition unit 200, an estimation unit 210, a confirmation unit 220, an execution unit 230, and a notification unit 240.

The acquisition unit 200 has the function of acquiring the vehicle type information 110, the travel history 120, and the car washing history 130 of the vehicle 12 from the onboard unit 20 of the vehicle 12. The acquisition unit 200 acquires the vehicle type information 110, the travel history 120, and the car washing history 130 from the onboard unit 20 when the vehicle 12 approaches the car wash 14 and communication is established between the control device 40 and the onboard unit 20.

The estimation unit 210 has the function of estimating the degree of dirtiness and dirty regions of the vehicle body surfaces of the vehicle 12 based on the vehicle type information 110, the travel history 120, and the car washing history 130 acquired by the acquisition unit 200. For example, in a case in which the estimation unit 210 determines from the car washing history 130 that a large number of days has passed since the last car wash, the estimation unit 210 estimates that the degree of dirtiness is high. Moreover, in a case in which the estimation unit 210 determines, from the travel history 120, that, since the last car wash, the vehicle 12 has been traveling on bad roads such as unpaved roads or the like or that the vehicle 12 has been traveling during rainy weather, or the like, the estimation unit 210 estimates that the degree of dirtiness is high. In this case, the estimation unit 210 estimates that the peripheries of the tire houses are dirty regions. Moreover, in a case in which the estimation unit 210 determines from the vehicle type information 110 that there are equipment such as an externally mounted rear mirror, a rear spoiler or the like for example, the estimation unit 210 estimates that the lower portions of such equipment are regions with higher degrees of dirtiness than the other portions of the vehicle body surfaces.

The confirmation unit 220 has the function of confirming the state of dirtiness of the vehicle body surfaces on the basis of the images captured by the camera 46 that captures images of the vehicle body surfaces of the vehicle 12. In particular, after a car wash that is based on the car washing menu has been carried out, the confirmation unit 220 of the present exemplary embodiment acquires captured images of the vehicle body surfaces including the dirty regions estimated by the estimation unit 210, and confirms the cleaned states of the respective portions.

The execution unit 230 has the function of driving the cleaning device 42 and executing car washing of the vehicle 12. The execution unit 230 executes the car washing based on the type of and the equipment of the vehicle 12, and the car washing menu corresponding to the dirtiness estimated by the estimation unit 210.

The notification unit 240 has the function of notifying the onboard unit 20 of the vehicle 12 and the terminal 16 that is possessed by the driver of the vehicle 12, of information relating to the car washing. For example, the notification unit 240 notifies the onboard unit 20 and the terminal 16 of information indicating that the car washing has been completed or information indicating that the car washing has been interrupted due to an error. Further, the notification unit 240 may inform the onboard unit 20 and the terminal 16 of the results of dirt removal after the car wash.

(Flow of Control)

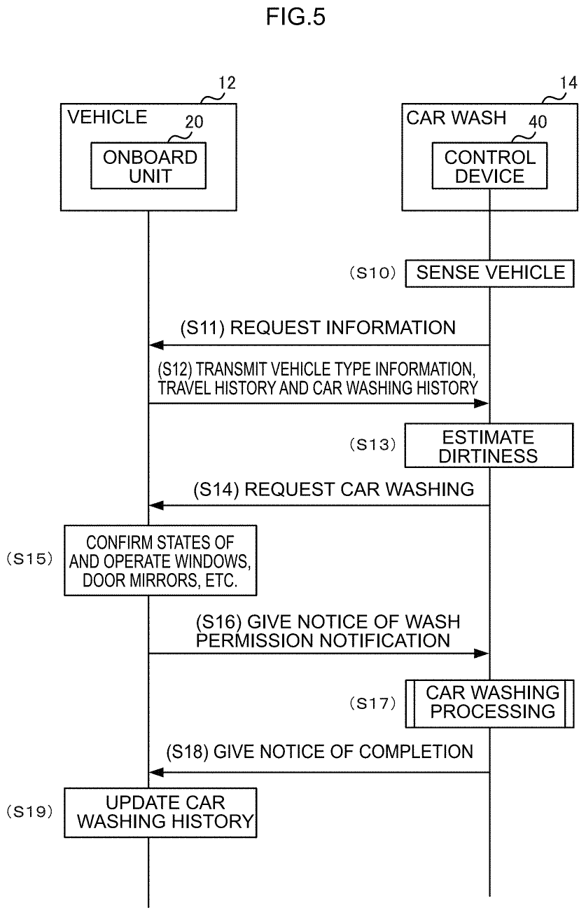

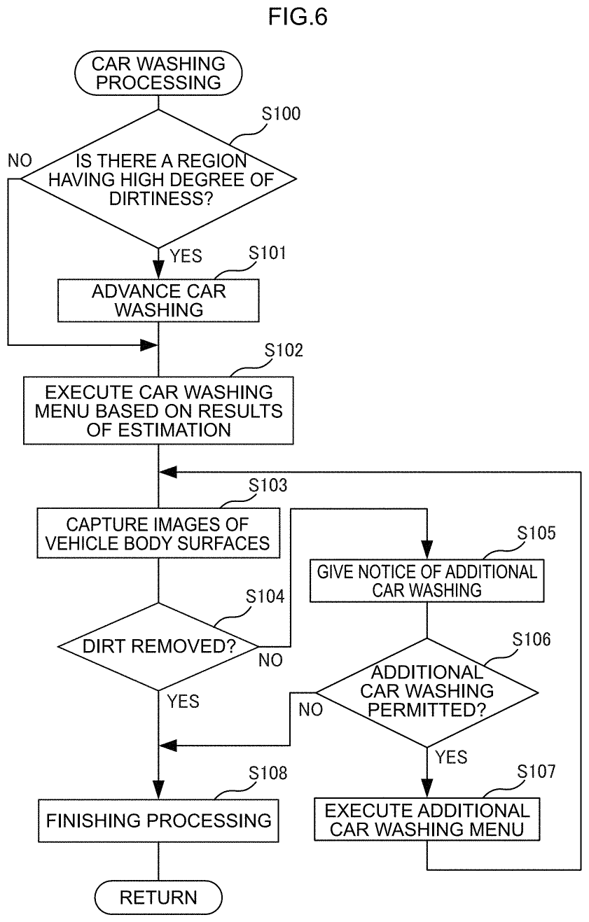

The flow of the processing that serves as the car washing method that executes car washing of the vehicle 12 in the present exemplary embodiment, is described with reference to the sequence diagram of FIG. 5 and the flowchart of FIG. 6. The processing at the control device 40 is executed due to the CPU 40A functioning as the acquisition unit 200, the estimation unit 210, the confirmation unit 220, the execution unit 230, and the notification unit 240.

In step S10 in FIG. 5, at the car wash 14, the CPU 40A senses the vehicle 12. The CPU 40A may sense the vehicle 12 by using, for example, the sensors 44 or the camera 46, or may sense the vehicle 12 on the basis of the condition that communication with the onboard unit 20 has been established.

In step S11, at the car wash 14, the CPU 40A issues an information request to the onboard unit 20. More specifically, the CPU 40A transmits a command requesting information to the onboard unit 20.

In step S12, at the onboard unit 20, in response to the information request, the CPU 20A transmits the vehicle type information 110, the travel history 120, and the car washing history 130 to the control device 40.

In step S13, at the car wash 14, the CPU 40A estimates the dirtiness of the vehicle body surfaces of the vehicle 12 based on the vehicle type information 110, the travel history 120, and the car washing history 130.

In step S14, at the car wash 14, the CPU 40A requests the onboard unit 20 to wash the vehicle. More specifically, the CPU 40A transmits a command to the onboard unit 20 requesting execution of car washing.

In step S15, at the onboard unit 20, the CPU 20A executes state confirming of and operation of the windows, the door mirrors 26, and the like in response to the car washing request. For example, in a case in which a window is open as a result of the state confirming, the CPU 20A operates the power window 25 via the body ECU 22A to close the open window. Moreover, for example, in a case in which the door mirror 26 is extended as a result of the state confirming, the CPU 20A operates the door mirror 26 via the body ECU 22A to fold the extended door mirror 26 in toward the vehicle body side.

In step S16, at the onboard unit 20, the CPU 20A transmits a wash permission notification to the control device 40.

In step S17, at the car wash 14, the CPU 40A receives the wash permission notification and executes car washing processing. Details of the car washing processing are described later.

In step S18, at the car wash 14, the CPU 40A notifies the onboard unit 20 of completion. More specifically, the CPU 40A transmits information to the onboard unit 20 to the effect that the car washing has been completed.

In step S19, at the onboard unit 20, the CPU 20A updates the car washing history 130.

Next, the car washing processing executed at the control device 40 in step S17 is described with reference to the flowchart of FIG. 6.

In step S100 in FIG. 5, the CPU 40A determines whether or not there is a region at the vehicle body surfaces of the vehicle 12 that has a high degree of dirtiness. In a case in which the CPU 40A determines that there is a region with a high degree of dirtiness (in the case of YES in step S100), processing proceeds to step S101. On the other hand, in a case in which the CPU 40A determines that there is no region with a high degree of dirtiness (in the case of NO in step S100), processing proceeds to step S102.

In step S101, the CPU 40A carries out advance car washing. In the advance car washing, the CPU 40A operates the cleaning device 42 to spray washing water onto the vehicle body surfaces to remove sand and dust, and to carry out brushing after spraying a cleaning agent that has a good scale removing performance. Note that the advance car washing may be carried out on only regions having high degrees of dirtiness.

In step S102, the CPU 40A executes car washing by using a car washing menu that is based on the results of estimating the dirtiness. In this case, the CPU 40A executes the car washing from a region having a high degree of dirtiness. For example, at a region with a high degree of dirtiness, the CPU 40A moves a brush reciprocatingly plural times, and/or reduces the moving speed of the brush with respect to the vehicle body surface. In step S102, the steps up to a step of rinsing of the vehicle body surfaces are executed.

In step S103, the CPU 40A captures images of the vehicle body surfaces of the vehicle 12.

In step S104, the CPU 40A determines whether or not dirt on the vehicle body surfaces has been removed. In a case in which the CPU 40A determines that dirt on the vehicle body surfaces has been removed (in the case of YES in step S104), processing proceeds to step S108. On the other hand, in a case in which the CPU 40A determines that dirt on the vehicle body surfaces has not been removed (in the case of NO in step S104), processing proceeds to step S105.

In step S105, the CPU 40A gives notice of additional washing of the vehicle 12. The notification of additional car washing is given to at least one of the onboard unit 20 of the vehicle 12 and the terminal 16 of the driver of the vehicle 12.

In step S106, the CPU 40A determines whether or not additional car washing has been permitted. More specifically, the CPU 40A determines whether or not a command expressing the permission to carry out additional car washing has been received from the onboard unit 20 or the terminal 16 that was notified of the additional car washing. In a case in which the CPU 40A determines that additional car washing has been permitted (in the case of YES in step S106), processing proceeds to step S107. On the other hand, in a case in which the CPU 40A determines that additional car washing is not permitted (in the case of NO in step S106), processing proceeds to step S108.

In step S107, the CPU 40A executes the additional car washing menu. Namely, the CPU 40A sprays the cleaning agent while focusing on the vehicle body surfaces at which dirt remains, and carries out brushing to further remove dirt.

In step S103, the CPU 40A executes finishing processing. Namely, the CPU 40A operates the blowers to remove the washing water (water droplets) remaining on the vehicle body surfaces. Then, the car washing processing is ended.

### SUMMARY

At the control device 40 that serves as the car washing device, the CPU 40A estimates the dirtiness of the vehicle body surfaces of the vehicle 12 based on the vehicle type information 110, the travel history 120, and the car washing history 130 acquired from the vehicle 12, and executes car washing that corresponds to the estimated degree of dirtiness. Due thereto, in a case in which the degree of dirtiness is high, the vehicle can be washed in advance while taking time, and, in a case in which the degree of dirtiness is low, a simple car washing can be carried out. Therefore, car washing of the vehicle 12 can be carried out with minimal time and resources.

Note that, when estimating the dirtiness of the vehicle body surfaces of the vehicle 12, it suffices to use at least the vehicle type information 110 and the travel history 120. However, in the present exemplary embodiment, the accuracy of estimating the dirtiness can be improved by adding the car washing history 130 of the vehicle 12 in carrying out determination.

Moreover, in accordance with the present exemplary embodiment, car washing can be carried out efficiently by executing the car washing from the regions whose estimated degrees of dirtiness are high.

Moreover, after the car washing has been executed, the control device 40 of the present exemplary embodiment confirms the cleaned states of the regions whose degrees of dirtiness were estimated to be high prior to the car washing on the basis of the captured images of the camera 46, and executes car washing once more in cases in which the removal of dirt is insufficient. Accordingly, in accordance with the present exemplary embodiment, dirt on the vehicle body surfaces of the vehicle 12 can be removed even in cases in which the estimating of dirtiness is insufficient.

Moreover, after execution of car washing, the control device 40 of the present exemplary embodiment confirms the cleaned states of the vehicle body surfaces based on captured images of the camera 46, and, in a case in which there is a region at which the removal of dirt is insufficient, notifies at least one of the onboard unit 20 and the terminal 16 that the removal of dirt is insufficient. Due thereto, in accordance with the present exemplary embodiment, in cases in which the removal of dirt on the vehicle body surfaces is insufficient, the user can be asked to select whether additional car washing is to be performed, or whether car washing is to be ended.

The present exemplary embodiment is configured such that additional car washing can be executed in a case in which the removal of dirt at a region that was estimated to be dirty before the car washing is insufficient. However, the accuracy of the estimation of dirtiness can be improved by correcting the estimation logic that estimates the dirtiness, based on the removal of dirt with respect to the estimation results.

### Notes

Note that, in the above exemplary embodiments, when the car washing has been completed, by transmitting the captured images from both before the car washing and after the car washing that have been captured by the camera 46 to at least one of the onboard unit 20 and the terminal 16, the cleaning effects and usefulness of the car washing machine 14 can be conveyed to the user.

Further, for example, based on the results of estimating the dirtiness and on the captured images of the camera 46, the locations of the regions having high degrees of dirtiness may be compiled, and this compiled information may be transmitted to at least one of the onboard unit 20 and the terminal 16. Moreover, for example, based on the results of estimating of the dirtiness and on the captured images of the camera 46, the types of dirtiness (e.g., bird dung, sand, mud, pollen, rain tracks, and the like) may be compiled, and the compiled information may be transmitted to at least one of the onboard unit 20 and the terminal 16.

Note that the various processings that are executed by the CPU 20A and the CPU 40A reading and executing software (programs) in the above exemplary embodiment may be executed by any of various types of processors other than a CPU. Examples of processors in this case include PLDs (Programmable Logic Devices) whose circuit structure can be changed after production such as FPGAs (Field-Programmable Gate Arrays) and the like, and dedicated electrical circuits that are processors having circuit structures that are designed for the sole purpose of executing specific processings such as ASICs (Application Specific Integrated Circuits) and the like, and the like. Further, the above-described processings may be executed by one of these various types of processors, or may be executed by a combination of two or more of the same type or different types of processors (e.g., plural FPGAs, or a combination of a CPU and an FPGA, or the like). Further, the hardware structures of these various types of processors are, more concretely, electrical circuits that combine circuit elements such as semiconductor elements and the like.

The above exemplary embodiment describes a form in which the respective programs are stored in advance (installed) in a non-transitory storage medium readable by a computer. For example, the control program 100 at the onboard unit 20 is stored in advance in the ROM 2013, and the processing program 150 at the control device 40 is stored in advance in the storage 40D. However, the present disclosure is not limited to this, and the respective programs may be provided in forms of being recorded on a non-transitory storage medium such as a CD-ROM (Compact Disc Read Only Memory), a DVD-ROM (Digital Versatile Disc Read Only Memory), a USB (Universal Serial Bus) memory, or the like. Further, the programs may be provided in forms downloadable from an external device over a network.

The flow of processings described in the above exemplary embodiment is an example, and unnecessary steps may be deleted, new steps may be added, or the order of processings may be rearranged within a scope that does not depart from the gist of the present disclosure.

What is claimed is:

1. A car washing device, comprising:
a processor, wherein the processor is configured to:
acquire vehicle type information and a travel history from a vehicle;
estimate dirtiness of the vehicle based on the vehicle type information and the travel history; and
execute car washing corresponding to an estimated degree of dirtiness.

2. The car washing device of claim 1, wherein the processor executes car washing beginning from a region having a high estimated degree of dirtiness.

3. The car washing device of claim 1, wherein the processor is configured to:
acquire a cleaned state of the vehicle after execution of car washing, and
execute car washing once more in a case in which there is a region in which removal of dirt is insufficient.

4. The car washing device of claim 1, wherein the processor is configured to:
acquire a cleaned state of the vehicle after execution of car washing, and
in a case in which there is a region in which removal of dirt is insufficient, notify a user that removal of dirt is insufficient.

5. The car washing device of claim 3, wherein, in a case in which there is a region in which removal of dirt is insufficient, the processor corrects logic that is configured to estimate the dirtiness of the vehicle.

6. The car washing device of claim 1, wherein the processor is configured to:
estimate the dirtiness of the vehicle based on a car washing history of the vehicle in addition to the vehicle type information and the travel history, and
execute car washing corresponding to the estimated degree of dirtiness.

7. A car washing system, comprising:
the car washing device of claim 1; and
a vehicle control device installed in the vehicle and connected to the car washing device by communication.

8. A car washing method, by which a computer executes processing comprising:
acquiring vehicle type information and a travel history from a vehicle;
estimating dirtiness of the vehicle based on the vehicle type information and the travel history; and
executing car washing corresponding to an estimated degree of dirtiness.

9. A non-transitory storage medium storing a car washing program executable by a computer to perform processing, the processing comprising:
acquiring vehicle type information and a travel history from a vehicle;
estimating dirtiness of the vehicle based on the vehicle type information and the travel history; and
executing car washing corresponding to an estimated degree of dirtiness.
